(19) United States
(12) Patent Application Publication
(10) Pub. No.: US 2014/0006080 A1
(43) Pub. Date: Jan. 2, 2014

(54) INFORMATION PROCESSING APPARATUS, INFORMATION PROCESSING METHOD, AND NON-TRANSITORY COMPUTER READABLE RECORDING MEDIUM

(71) Applicant: FUJI XEROX CO., LTD., Tokyo (JP)

(72) Inventor: Minoru YUSA, Kanagawa (JP)

(73) Assignee: FUJI XEROX CO., LTD., Tokyo (JP)

(21) Appl. No.: 13/753,945

(22) Filed: Jan. 30, 2013

(30) Foreign Application Priority Data
Jul. 2, 2012 (JP) 2012-148474

(51) Int. Cl. G06Q 10/10

(52) U.S. Cl. CPC G06Q 10/1095
USPC 705/7.19

(57) ABSTRACT

An information processing apparatus includes an emission amount information acquisition unit that, on each user of a plurality of users planning to participate in a scheduled meeting and being able to move to a meeting room before a scheduled start time of the meeting among a plurality of predetermined meeting rooms, acquires information on an emission amount of carbon dioxide that is released in movement of the user to participate in the meeting in the meeting room, and a determination unit that determines one or a plurality of meeting rooms to be used for the meeting depending on the emission amount information acquired by the emission amount information acquisition unit.

### CROSS-REFERENCE TO RELATED APPLICATIONS

This application is based on and claims priority under 35 USC 119 from Japanese Patent Application No. 2012-148474 filed Jul. 2, 2012.

### BACKGROUND

### Technical Field

The present invention relates to an information processing apparatus, and information processing method, and a non-transitory computer readable recording medium.

### SUMMARY

According to an aspect of the invention, an information processing apparatus is provided. The information processing apparatus includes an emission amount information acquisition unit that, on each user of a plurality of users planning to participate in a scheduled meeting and being able to move to a meeting room before a scheduled start time of the meeting among a plurality of predetermined meeting rooms, acquires information on an emission amount of carbon dioxide that is released in movement of the user to participate in the meeting in the meeting room, and a determination unit that determines one or a plurality of meeting rooms to be used for the meeting depending on the emission amount information acquired by the emission amount information acquisition unit.

### BRIEF DESCRIPTION OF THE DRAWINGS

Exemplary embodiments of the present invention will be described in detail based on the following figures, wherein:

FIG. 1 illustrates a configuration of a schedule management apparatus;

FIG. 2 illustrates an example of schedule information;

FIG. 3 illustrates an example of meeting room information;

FIG. 4 illustrates an example of location-to-location information;

FIG. 5 illustrates an example of unit emission amount information;

FIG. 6 illustrates an example of session schedule information;

FIG. 7 is a flowchart illustrating a process executed by the schedule management apparatus;

FIG. 8 is a continuation of the process of FIG. 7 executed by the schedule management apparatus;

FIG. 9 illustrates an example of in-time and late arrival information;

FIG. 10 illustrates an example of an effective location pattern;

FIG. 11 illustrates an example of an arrangement pattern;

FIG. 12 illustrates an example of an effective meeting room pattern;

FIG. 13 illustrates an example of session arrangement data; and

FIG. 14 illustrates a total emission amount of each session arrangement.

### DETAILED DESCRIPTION

Embodiments of the present invention are described in detail below.

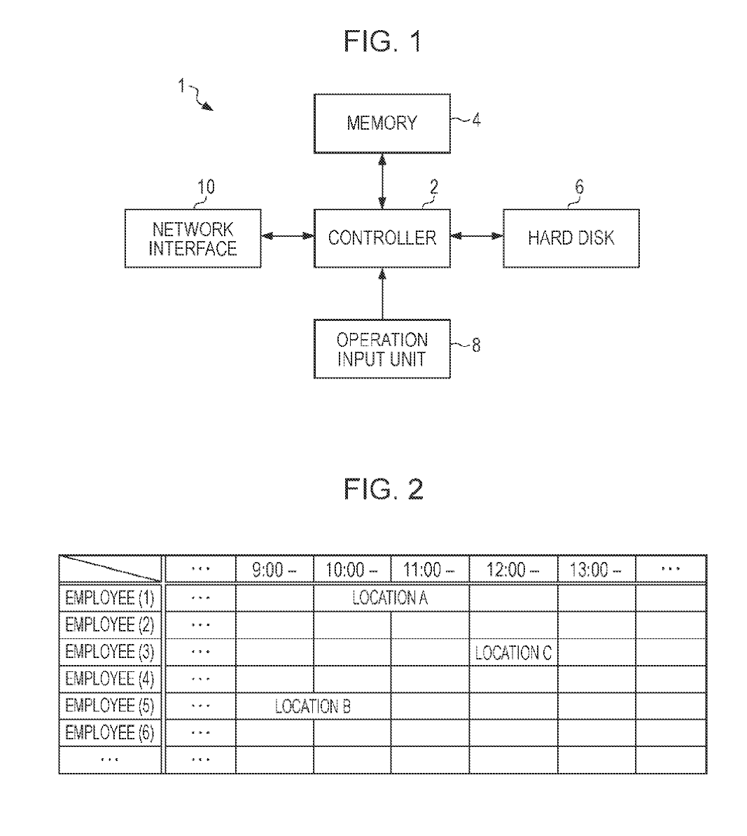

FIG. 1 illustrates a configuration of a schedule management apparatus 1 of an exemplary embodiment of the present invention. As illustrated in FIG. 1, the schedule management apparatus 1 is a server computer, and includes controller 2, memory 4, hard disk 6, operation input unit 8, and network interface 10. The memory 4 stores a program that has been read from a computer-readable information storage medium (such as digital versatile disk (DVD)-ROM (registered trademark)). The controller 2 executes a variety of information processes in accordance with the program. The program may be downloaded via a network and stored on the memory 4.

The hard disk 6 stores a variety of information. Information stored on the hard disk 6 is described below. The operation input unit 8 may be a mouse and a keyboard, for example, and outputs, to the controller 2, an operation signal indicating content of operation performed by a user. The network interface 10 serves as an interface to connect the schedule management apparatus 1 to the network. The network interface 10 receives information via the network, or outputs information over the network. The schedule management apparatus 1 exchanges data with a client apparatus (not illustrated) via the network.

The schedule management apparatus 1 is used to manage the schedule of each employee working for a company (hereinafter referred to as a company X). To manage the schedule of each employee, the hard disk 6 stores schedule information of each employee. FIG. 2 illustrates an example of the schedule information. As illustrated in FIG. 2, the schedules of the employees are listed during a period from 9:00 to 13:00 on one day. As illustrated in FIG. 2, employee (1) has a plan during two hours from 10:00 to 12:00 and is thus scheduled at location A as one of the three business depots of the company X during this period. Employee (3) has a plan during a one-hour period from 12:00 to 13:00, and is thus scheduled to stay at location C of the three business depots of the company X. Employee (5) has a plan from 9:00 and is scheduled to stay at location B of the three business depots.

Each employee has their own fixed home location. If each employee has no particular plan, he or she usually stays at their home location.

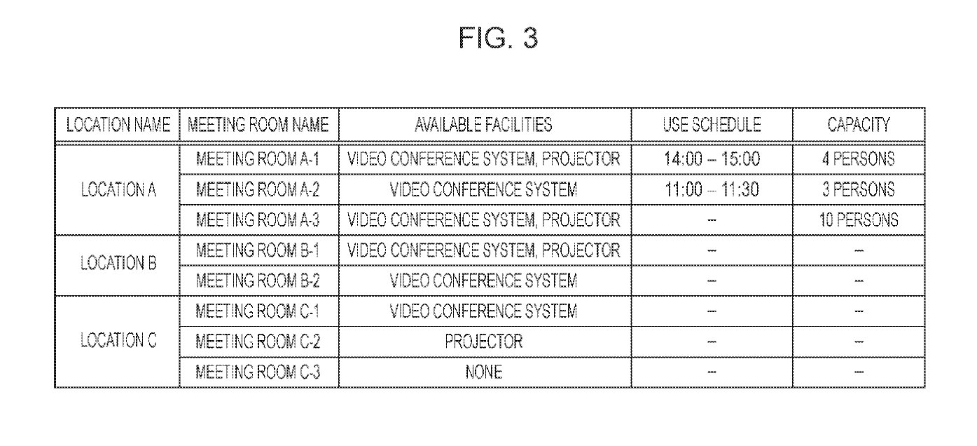

The schedule management apparatus 1 is also used to manage the use schedule of the meeting room. The hard disk 6 stores meeting room information to manage a use schedule of the meeting room. FIG. 3 illustrates an example of the meeting room information. The meeting room information indicates the use schedule of each meeting room. More specifically, the meeting room information contains information indicating the use schedule of each meeting room in association with the meeting room name thereof. As illustrated in FIG. 3, a meeting room A-1 is scheduled to be used from 14:00 to 15:00. The meeting room information also indicates a facility available at the meeting room in association with the meeting room name thereof. The meeting room information also contains information about an accommodation capacity thereof. More specifically, the meeting room information contains information indicating the number of persons the meeting room can take in association with the meeting room name of the meeting room. The meeting room information also indicates a location which has the meeting room. More specifically, the meeting room information holds the name of the location to which the meeting room belongs to in association with the meeting room name of the meeting room. According to the exemplary embodiment, the location A includes three meeting rooms, i.e., meeting room A-1, meeting room A-2, and meeting room A-3 as illustrated in FIG. 3. The location B includes two meeting rooms, i.e., meeting room B-1, and meeting room B-2. The location C includes three meeting rooms, i.e., meeting room C-1, meeting room C-2, and meeting room C-3.

A meeting room of any location may be referred to as a “the meeting room of the location.”

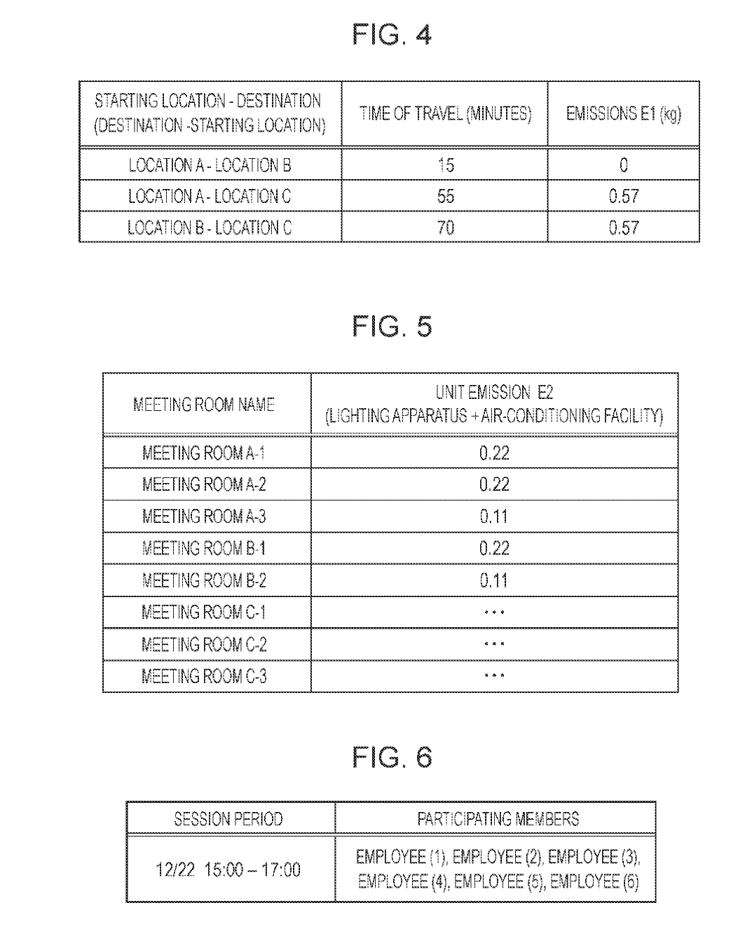

The hard disk 6 also stores location-to-location information that indicates time duration of travel between locations, and an amount of emission of carbon dioxide released in the movement from one location to another location. FIG. 4 illustrates an example of the location-to-location information. As illustrated in FIG. 4, the location-to-location information contains information about time duration to travel from one location to another location. The location-to-location information also contains information about an emission amount E1 of carbon dioxide released in the movement of a person between a pair of locations in association with the pair of locations. Since a distance between location A and location B is short, the person walks from location A to location B. Since a distance between location A and location C is long, a person may move by train. Also, if a distance between location B and location C is long, a person typically move by train, and then partly walks in the movement. The time duration of travel between location B and location C is 15 minutes longer than the time duration of travel between location A and location C, but emission amounts of carbon dioxide involved in the two travels remain the same. This is because the time duration of travel between location B and location C includes a walk of 15 minutes in addition to the movement by train.

The hard disk 6 also stores, in addition to the location-to-location information, unit emission amount information indicating an emission amount of carbon dioxide per unit time released in the use of a facility of the meeting room. FIG. 5 illustrates an example of the unit emission amount information. The unit emission amount information contains information indicating unit emission amount E2. The unit emission amount E2 is an amount of carbon dioxide released per unit time by lighting apparatuses and an air-conditioning system in the meeting room. The unit emission amount information also contains information on an emission amount Ep of carbon dioxide released per unit time by a projector in use, and information on an emission amount Et of carbon dioxide released per unit time by a video conference system in use. Optionally, the unit emission amount information may also contain information on an emission amount of carbon dioxide released per unit time by a printer in use.

As described above, the schedule management apparatus 1 is used to manage the schedule of each employee and the use schedule of the meeting room. The schedule management apparatus 1 is further used for an employee to register a schedule of a meeting to be held by themselves.

The employee accesses the schedule management apparatus 1 using a client apparatus, and inputs on a scheduler screen a session period of a scheduled meeting and a name of a participating member in the meeting as a session plan. The input information is transmitted as session plan information to the schedule management apparatus 1. FIG. 6 illustrates an example of the session plan information indicating the session period of the meeting, and the member participating in the meeting. Optionally, meeting material information may be input on the scheduler screen. In this case, the session plan information includes the meeting material information.

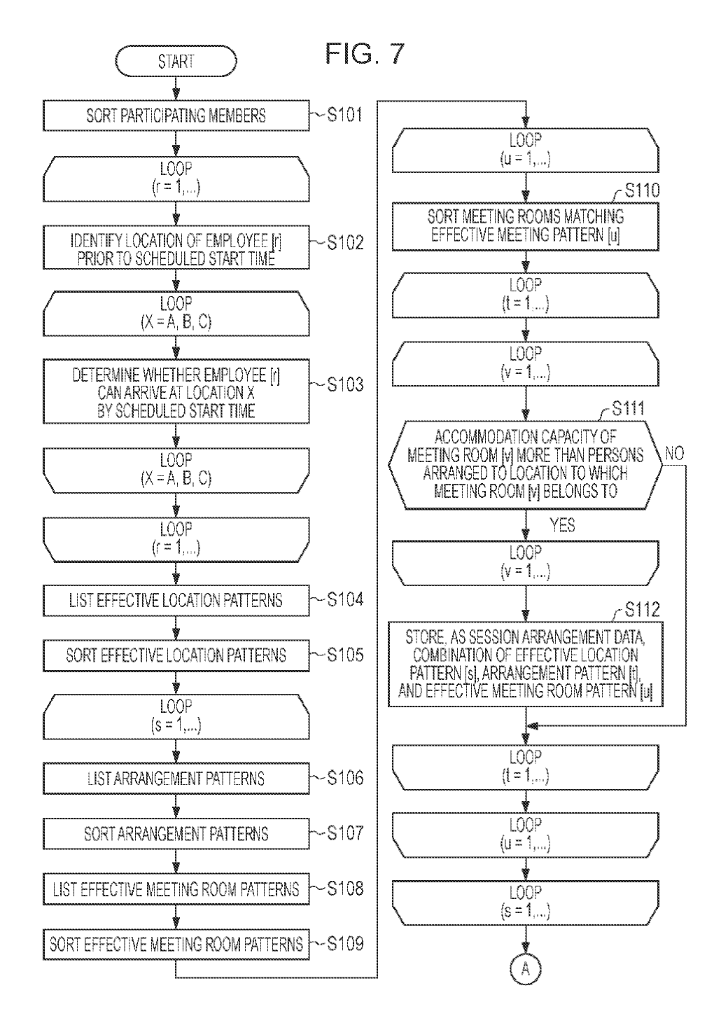

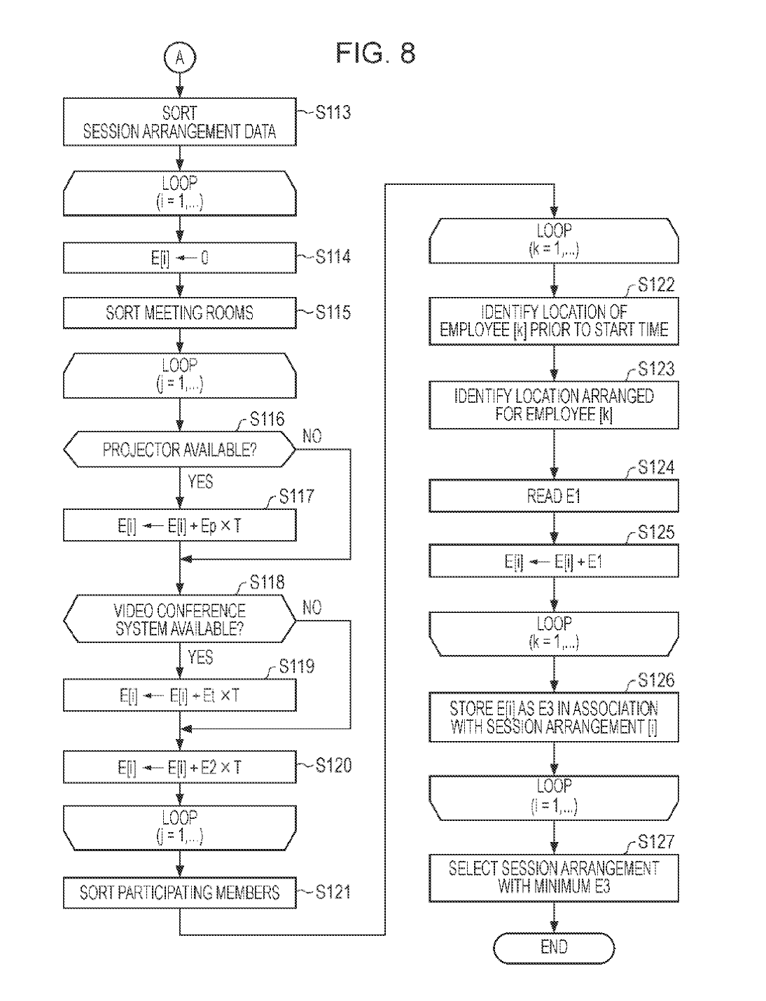

Upon receiving the session plan information, the schedule management apparatus 1 determines, in response to the session plan information, one or more meeting rooms for use in holding the meeting so that all the members can participate. When the schedule management apparatus 1 determines the meeting room so that all the member can participate, the schedule management apparatus 1 accounts for a load that the holding of the meeting is expected to impose on the environment. More specifically, if the session plan information is received, the schedule management apparatus 1 performs a process of FIGS. 7 and 8.

The controller 2 first sorts the members expected to participate in the meeting (S101). The controller 2 performs operations in S102 and S103 on all the participating members, starting with a first participating member. In this way, in-time/late arrival information is generated, indicating a location which each participating member can arrive in time before the scheduled start time (as described below). The operations in S102 and S103 are described. An r-th participating member is hereinafter referred to as an employee [r].

The controller 2 references the schedule information (see FIG. 2), and identifies the location of the employee [r] prior to the scheduled start time of the meeting (S102). If the employee [r] has no plan prior to the scheduled start time, the controller 2 determines as a predetermined location as the home location of the employee [r].

The controller 2 selects as location X each of location A through location C, successively, and references the location-to-location information (see FIG. 4), and the schedule information to determine whether the employee [r] can arrive at the location X before the scheduled start time (S103). If the employee [r] has no plan prior to the scheduled start time in the exemplary embodiment, the controller 2 unconditionally determines that the employee [r] can arrive in time (in-time arrival). If the location of the employee [r] is the same as the location X, the controller 2 unconditionally determines that the employee [r] is in the “in-time arrival.” If the employee [r] has a plan prior to the scheduled start time and the present location and the location X are different, the controller 2 identifies the time duration of travel from the present location to the location X in accordance with the location-to-location information, and then calculates time after the time duration of travel subsequent to the end of the plan. If the calculated time is prior to the scheduled start time, the controller 2 determines that the result is the “in-time arrival.” If the calculated time is after the scheduled start time, the controller 2 determines that the result is the “late arrival.”

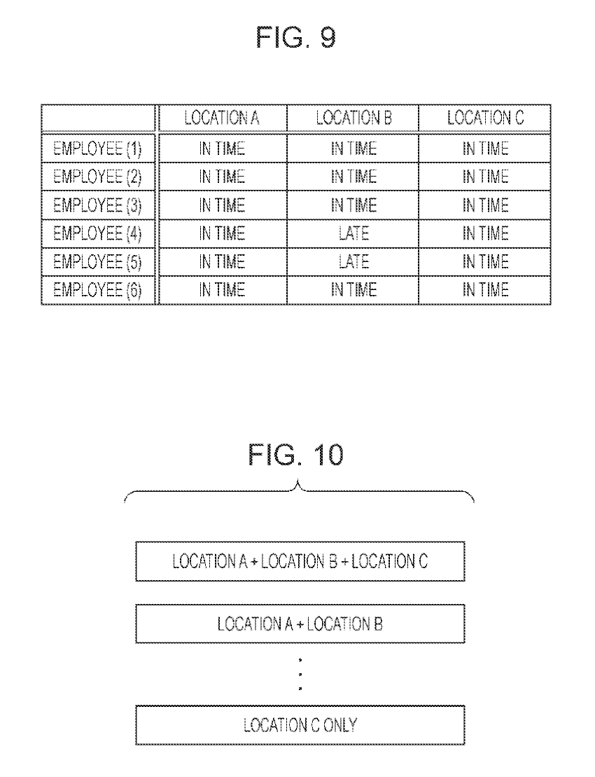

The controller 2 performs the operations in S102 and S103 on all the participating members. In response to a determination result of S103, the controller 2 generates in-time/late arrival information. FIG. 9 illustrates the in-time/late arrival information.

The controller 2 then references the in-time/late arrival information and lists a combination of locations where all the participating members can join (the combination of locations is hereinafter referred to as an effective location pattern) (S104). In the exemplary embodiment, the controller 2 first lists all combinations of locations including at least one of locations A through C. From among the listed combinations, the controller 2 references the in-time/late arrival information and determines a combination in which none of the participating members are late for the meeting in terms of the scheduled start time. The combination identified herein is listed as an effective location pattern. FIG. 10 illustrates an example of the effective location pattern.

The controller 2 then sorts the effective location patterns (S105), and performs operations in S106 through S112, starting with a first effective location pattern. The controller 2 lists session arrangements of the meetings so that all the member can participate. The operations in S106 through S112 are described below. In the following discussion, an s-th effective location pattern is referred to as an effective location pattern [s].

The controller 2 performs operations in S106 through S109 to list each session arrangement in which all the members can participate in a meeting room in the location of the effective location pattern [s]. More specifically, referring to the in-time/late arrival information, the controller 2 lists each arrangement pattern according to which each participating member who can arrive at a location before the scheduled start time is arranged for the location in the effective location pattern [s] (S106). FIG. 11 illustrates an example of the listed arrangement pattern. The listed arrangement pattern includes the number of persons arranged for each location.

The controller 2 sorts the listed arrangement patterns (S107).

Referring to the meeting room information, the controller 2 lists a meeting room combination which includes one meeting room of each location of in the effective location pattern [s] with all the participating members accommodated in the meeting room (S108). The meeting room combination is hereinafter referred to as an effective meeting room pattern. In the exemplary embodiment, the controller 2 first lists all the combinations, each including one meeting from each location in the effective location pattern [s]. The controller 2 excludes from a set of all the listed combinations a combination satisfying one of the following conditions in a group, and then lists each of the combinations in the set with that combination removed as an effective meeting room pattern.

### Condition 1

A meeting room scheduled to be used at least in part of the session period is included.

### Condition 2

A total number of persons all the meeting rooms can accommodate is less than a total number of participating members.

If plural locations are included in the effective location pattern [s], the following condition 3 is also added.

### Condition 3

A meeting room having no video conference system is included.

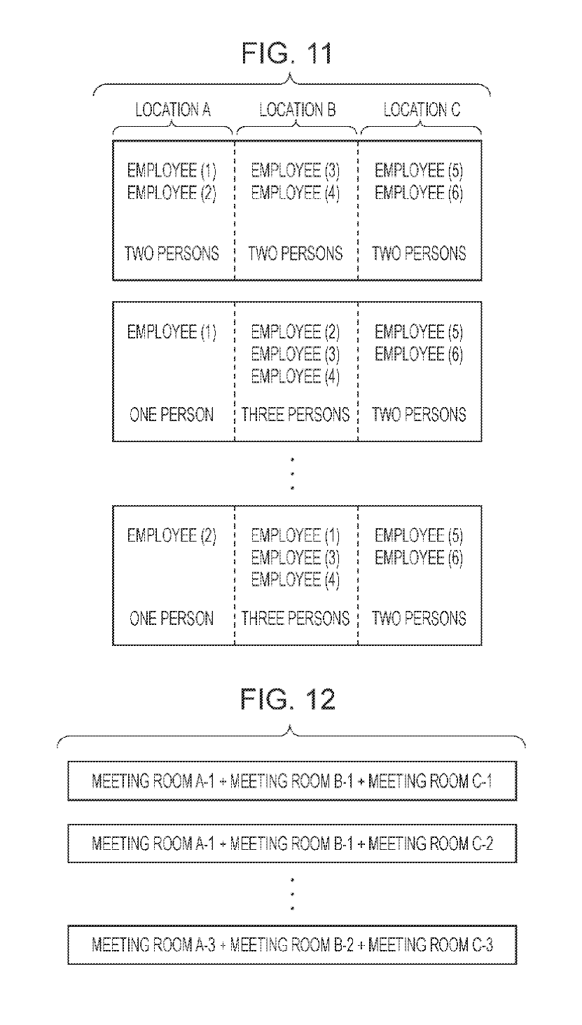

FIG. 12 illustrates an example of the listed effective meeting room patterns. Subsequent to S108, the controller 2 also sorts the effective meeting room patterns (S109).

The controller 2 performs operations in S110 and S112 on each combination of arrangement patterns and effective meeting room patterns, and then lists each session arrangement that allows all the expected members to participate in the meeting room in the location in the effective location pattern [s]. In the following discussion, a u-th effective meeting room pattern is referred to as an effective meeting room pattern [u], and a t-th arrangement pattern is referred to as an arrangement pattern [t].

More specifically, the controller 2 sorts the meeting rooms in the effective meeting room pattern [u] (S110). The controller 2 then performs an operation in S111 on the meeting room, starting with a first meeting room. In the following discussion, a v-th meeting room is referred to as a meeting room [v].

More specifically, the controller 2 references the meeting room information and the arrangement pattern [t] and determines whether the accommodation capacity of the meeting room [v] is more than the number of persons arranged for the location to which the meeting room [v] belongs (S111).

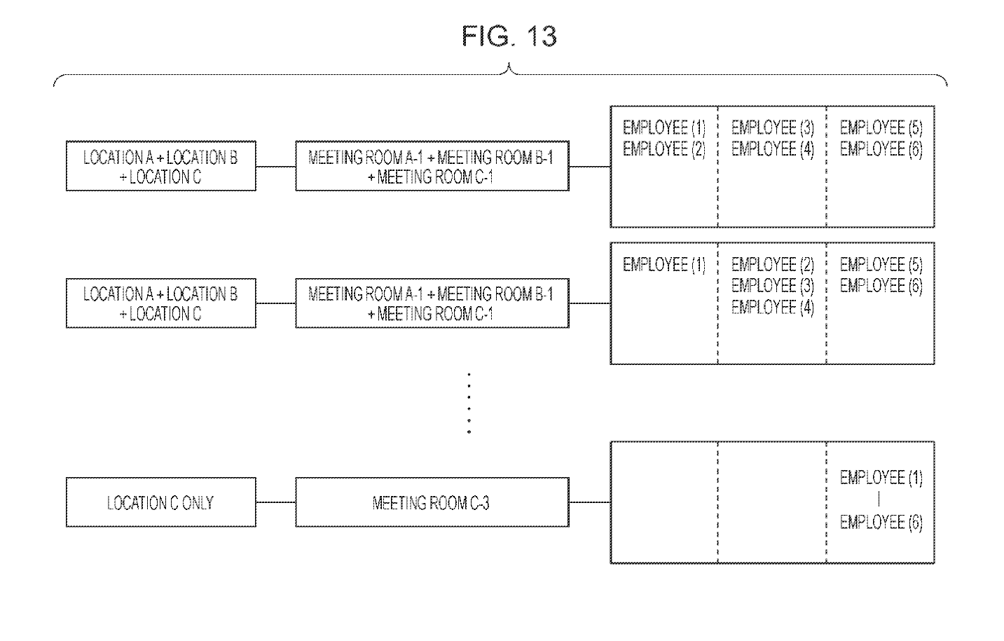

If determination results of all the meeting rooms in the effective meeting room pattern [u] are affirmative, the controller 2 stores on the memory 4 session arrangement data including the effective location pattern [s], the effective meeting room pattern [u], and the arrangement pattern [t] (S112). FIG. 13 illustrates an example of the listed session arrangement data.

If a non-affirmative answer is obtained in response to any of the meeting rooms in the effective meeting room pattern [u], not all the members are able to participate in the meeting. In such a case, the session arrangement data is not stored. The controller 2 performs the operation in S111 on a next arrangement pattern [t]. As described above, through the process of FIG. 7, the session arrangement of the meetings in which the members can participate is listed.

The controller 2 then performs the process of FIG. 8 in view of the load imposed on the environment, thereby determining a session arrangement that is actually adopted. More specifically, the controller 2 reads the session arrangement data stored on the memory 4 and sorts the read session arrangement data (S113). The controller 2 then calculates a total emission amount E3 of carbon dioxide by performing operations in S114 through S126 on the session arrangement data, starting with first session arrangement data. The total emission amount E3 of carbon dioxide is an amount of carbon dioxide released when a meeting is held in each of the session arrangement.

Here, i-th session arrangement data is referred to as session arrangement data [i]. A meeting room included in the effective meeting room pattern [u] in the session arrangement data [i] may be referred to as a meeting room used in the session arrangement [i].

The controller 2 sets value E[i] to be zero (S114). The controller 2 sorts the meeting rooms used in the session arrangement [i] (S115). In accordance with steps S116 through S120, the controller 2 (emission amount calculation unit) calculates an emission amount of carbon dioxide released when each meeting room is used for the meeting in operations in S116 through S120. The meeting room as a process interest is referred to as the meeting room [j]. The operations in S116 through S120 are described below.

The controller 2 references the meeting room information and then determines whether the meeting room [j] has a projector available therein, i.e., whether facilities available in the meeting room [j] includes a projector (S116). If the meeting room [j] has a projector (yes branch from S116), the controller 2 identifies a length T of the session period of the meeting from the session plan information, and obtains unit emission amount Ep contained in the unit emission amount information. The controller 2 then increments the value E[j] by a product of Ep and T (S117). The product indicates an emission amount of carbon dioxide released in the use of the projector during the session period. If the meeting room [j] has no projector (no branch from S116), the controller 2 proceeds to step S118 without incrementing E[i].

The controller 2 references the meeting room information and determines whether the meeting room [j] has a video conference system, i.e., facilities available in the meeting room [j] include a video conference system (S118). If the meeting room [j] has a video conference system (yes branch from S118), the controller 2 acquires Et contained in the unit emission amount information and then increments the value E[i] by a product of Et and T controller 2 (S119). The product indicates an emission amount of carbon dioxide released in the use of the video conference system during the session period. If the meeting room [j] has no video conference system (no branch from S118), the controller 2 proceeds to step S120 without incrementing E[i].

The controller 2 (the emission amount calculation unit) reads the unit emission amount E2 from the unit emission amount information, and increments the value E[i] by the unit emission amount E2 (S120).

Steps S116 through S120 have been described. The controller 2 (the emission amount calculation unit) identifies an emission amount of carbon dioxide released when each participating member moves for meeting by performing operations in S121 through S125.

As in step S101, the controller 2 sorts the participating members (S121). The controller 2 then executes steps in S122 through S125 on the participating members, starting with a first participating member. Steps in S122 through S125 are described below. Here, k-th participating member is referred to as an employee [k].

In the same manner as in step S102, the controller 2 (location identification unit) identifies a location of employee [k] prior to the scheduled start time (S122). In the arrangement pattern in the session arrangement [i], the controller 2 identifies a location (hereinafter referred to as location Y) where the employee [k] belongs (S123). The controller 2 reads from the location-to-location information the emission amount E1 associated with the present location and the location Y (S124), and then increments the value E[i] by the read emission amount E1.

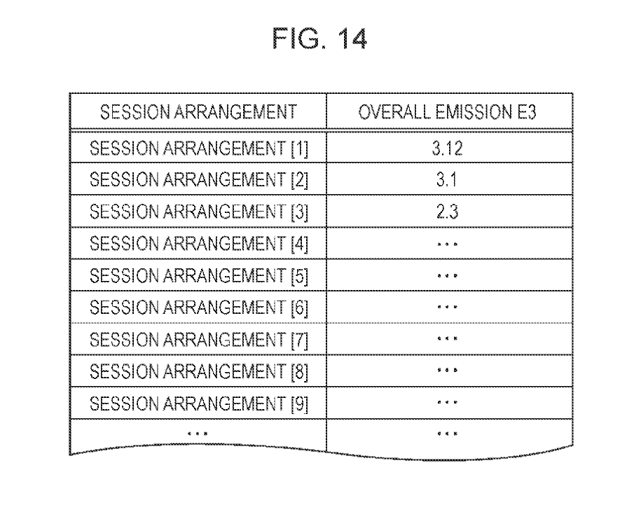

When steps S122 through S125 are performed on all participating members, the controller 2 stores on the memory 4 E[i] as the total emission amount E3 in association with the session arrangement [i] (S126). The total emission amount E3 indicates a total emission amount of carbon dioxide released when a meeting is held in the session arrangement [i]. Step S126 is performed in all the session arrangements, and the total emission amount E3 is stored on the memory 4. FIG. 14 illustrates the total emission amount E3 in each session arrangement.

The controller 2 (determination unit) selects a session arrangement having a minimum total emission amount E3 (S127), and determines the selected session arrangement as a session arrangement of the meeting. More specifically, using the selected session arrangement (the session arrangement data), the controller 2 updates the schedule of each member included in the schedule information, and updates the use schedule of the meeting room included in the meeting room information.

The controller 2 then transmits an e-mail to announce the scheduled meeting to each participating member. In response to a reply from a participating member, the controller 2 may modify the session arrangement.

The present invention is not limited to the above exemplary embodiment.

For example, the information of FIG. 14 may be presented to all the participating members. In such a case, the participating member may be notified of an emission amount of carbon dioxide on each session arrangement to be released when the participating member moves to participate in the meeting.

The same session arrangement may be further divided depending on whether the projector is used. Whether to use the projector may be determined taking into consideration the number of members, the number of pages of printed matter to be given to the members if no projector is used, and the session time of the meeting.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an emission amount information acquisition unit that, on each user of a plurality of users planning to participate in a scheduled meeting and being able to move to a meeting room before a scheduled start time of the meeting among a plurality of predetermined meeting rooms, acquires information on an emission amount of carbon dioxide that is released in movement of the user to participate in the meeting in the meeting room; and
a determination unit that determines one or a plurality of meeting rooms to be used for the meeting depending on the emission amount information acquired by the emission amount information acquisition unit.

2. The information processing apparatus according to claim 1, wherein each of the plurality of predetermined meeting rooms belongs to one of a plurality of locations, and
wherein the information processing apparatus further comprises a location identification unit that identifies a location where each user is present before the scheduled start time in accordance with schedule information representing a schedule of each user, and
wherein the emission amount information acquisition unit acquires the emission amount information responsive to information indicating carbon dioxide released in the movement of each user from location to location.

3. The information processing apparatus according to claim 1, further comprising an emission amount calculation unit that, on a meeting room which a user is able to move to before the scheduled start time out of the plurality of predetermined meeting rooms, calculates an emission amount of carbon dioxide released in the use of the meeting room for the meeting in accordance with information indicating an emission amount of carbon dioxide per unit time released in use of a facility in the meeting room,
wherein the determination unit determines one or a plurality of meeting rooms for use in the meeting in view of the emission amount indicated by the emission amount information acquired by the emission amount information acquisition unit and the emission amount calculated by the emission amount calculation unit.

4. The information processing apparatus according to claim 2, further comprising an emission amount calculation unit that, on a meeting room which a user is able to move to before the scheduled start time out of the plurality of predetermined meeting rooms, calculates an emission amount of carbon dioxide released in the use of the meeting room for the meeting in accordance with information indicating an emission amount of carbon dioxide per unit time released in use of a facility in the meeting room,
wherein the determination unit determines one or a plurality of meeting rooms for use in the meeting in view of the emission amount indicated by the emission amount information acquired by the emission amount information acquisition unit and the emission amount calculated by the emission amount calculation unit.

5. An information processing method comprising:
on each user of a plurality of users planning to participate in a scheduled meeting and being able to move to a meeting room before a scheduled start time of the meeting among a plurality of predetermined meeting rooms, acquiring information on an emission amount of carbon dioxide that is released in movement of the user to participate in the meeting in the meeting room; and
determining one or a plurality of meeting rooms to be used for the meeting depending on the acquired emission amount information.

6. A non-transitory computer readable medium storing a program causing a computer to execute a process for processing information, the process comprising:
on each user of a plurality of users planning to participate in a scheduled meeting and being able to move to a meeting room before a scheduled start time of the meeting among a plurality of predetermined meeting rooms, acquiring information on an emission amount of carbon dioxide that is released in movement of the user to participate in the meeting in the meeting room; and
determining one or a plurality of meeting rooms to be used for the meeting depending on the acquired emission amount information.
